(19) United States
(12) Patent Application Publication
(10) Pub. No.: US 2013/0145159 A1
(43) Pub. Date: Jun. 6, 2013

(54) TERMINAL APPARATUS FOR TRANSMITTING OR RECEIVING A SIGNAL CONTAINING PREDETERMINED INFORMATION

(71) Applicant: Sanyo Electric Co., Ltd., Osaka (JP)

(72) Inventors: Ken NAKAOKA, Ichinomiya-shI (JP); Yoshihiro HORI, Gifu-shi (JP)

(73) Assignee: SANYO ELECTRIC CO., LTD., Osaka (JP)

(21) Appl. No.: 13/739,973

(22) Filed: Jan. 11, 2013

Related U.S. Application Data
(63) Continuation of application No. PCT/JP2011/004020, filed on Jul. 13, 2011.

(30) Foreign Application Priority Data
Jul. 13, 2010 (JP) 2010-158349

(51) Int. Cl. H04L 9/32

(52) U.S. Cl. CPC H04L 9/3247
USPC 713/161

(57) ABSTRACT

A modem unit and the like receive packets sent from a base station apparatus and receives packets sent from other terminal apparatuses. A processing unit processes the received packets. For the packets received by the modem unit and the like from the base station apparatus, a private key complying with a public key cryptosystem is used for a digital signature, whereas a symmetric key complying with a symmetric key cryptosystem is used for data. For the packets received from the other terminal apparatuses, a symmetric key complying with the symmetric key cryptosystem is used for the digital signature.

### BACKGROUND OF THE INVENTION

1. Field of the Invention

The present invention relates to a communication technology, and it particularly relates to a terminal apparatuses for transmitting or receiving a signal containing predetermined information.

2. Description of the Related Art

Road-to-vehicle communication has been under investigation in an effort to prevent collision accidents of vehicles on a sudden encounter at an intersection. In a road-to-vehicle communication, information on conditions at an intersection is communicated between a roadside unit and an in-vehicle unit. Such a road-to-vehicle communication requires installation of roadside units, which means a great cost of time and money.

In contrast to this, an inter-vehicular communication, in which information is communicated between in-vehicle units, has no need for installation of roadside units. In that case, current position information is detected in real time by GPS (Global Positioning System) or the like and the position information is exchanged between the in-vehicle units. Thus it is determined on which of the roads leading to the intersection the driver's vehicle and the other vehicles are located.

Used in wireless LANs (Local Area Networks) conforming to standards, such as IEEE 802.11, is an access control function called Carrier Sense Multiple Access with Collision Avoidance (CSMA/CA). In such a wireless LAN, therefore, the same wireless channel is shared by a plurality of terminal apparatuses. In this CSMA/CA, the packets are transmitted after it is verified that other packets are not being transmitted.

On the other hand, when the wireless LAN is applied to the inter-vehicular communication such as an intelligent transport system (ITS), a need arises to transmit information to a large indefinite number of terminal apparatuses and therefore it is desirable that the secrecy of communication contents be ensured.

### SUMMARY OF THE INVENTION

The present invention has been made in view of the foregoing circumstances, and a purpose thereof is to provide a technology of ensuring the secrecy of communication contents.

In order to resolve the above-described problems, a terminal apparatus according to one embodiment of the present invention includes: a communication unit configured to receive a packet sent from a base station apparatus; and a processing unit configured to process the packet received by said communication unit. In the packet received by communication unit from the base station apparatus, a private key complying with a public key cryptosystem is used for a digital signature, and a symmetric key complying with a symmetric key cryptosystem is used for data.

Optional combinations of the aforementioned constituting elements, and implementations of the invention in the form of methods, apparatuses, systems, recording media, computer programs and so forth may also be practiced as additional modes of the present invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 shows a structure of a communication system according to an exemplary embodiment of the present invention.

FIG. 2 shows another structure of a communication system according to an exemplary embodiment of the present invention.

FIG. 3 shows a base station apparatus shown in FIG. 1 and FIG. 2.

FIGS. 4A to 4D each shows a format of frame defined in the communication systems of FIG. 1 and FIG. 2.

FIGS. 5A and 5B each shows a structure of subframe of FIGS. 4A to 4D.format of frame defined in the communication systems of FIG. 1 and FIG. 2.

FIGS. 6A to 6C each shows a format of MAC frame stored in a packet defined in the communication system of FIG. 1 and FIG. 2.

FIGS. 7A and 7B each shows another structure Of subframe of FIGS. 4A to 4D.

FIG. 8 shows a structure of a terminal apparatus mounted on a vehicle shown in FIG. 1 and FIG. 2.

FIG. 9 is a flowchart showing a procedure for generating a message header in the base station apparatus of FIG. 3.

FIG. 10 is a flowchart showing a procedure for inserting a message header in the base station apparatus of FIG. 3.

FIG. 11 is a flowchart showing a procedure for determining the broadcasting timing in the terminal apparatus of FIG. 8.

FIG. 12 shows a format of security frame stored in a MAC frame defined in the inter-vehicular communication system according to an exemplary embodiment of the present invention.

FIGS. 13A and 13B show processing contents for the security frame of FIG. 12.

FIGS. 14A to 14D show an overview of security processing performed by a base station apparatus according to an exemplary embodiment of the present invention.

FIG. 15 is a flowchart showing a procedure for inserting a message header in a base station apparatus according to a fourth modification.

### DETAILED DESCRIPTION OF THE INVENTION

The invention will now be described by reference to the preferred embodiments. This does not intend to limit the scope of the present invention, but to exemplify the invention.

The present invention will be outlined before it is explained in detail. Exemplary embodiments of the present invention relate to a communication system that carries out not only an inter-vehicular communication between terminal apparatuses mounted on vehicles but also a road-to-vehicle communication from a base station apparatus installed in an intersection and the like to the terminal apparatuses. As the inter-vehicular communication, a terminal apparatus transmits, by broadcast, a packet in which the information (hereinafter referred to as “data” also) such as the traveling speed and position of the vehicle is stored. And the other terminal apparatuses receive the packets and recognize the approach or the like of the vehicle based on the data. Here, the base station apparatus repeatedly specifies a frame that contains a plurality of subframes. To perform the road-to-vehicle communication, the base station apparatus selects any of the plurality of subframes and transmits, by broadcast, a packet that contains control information and the like, in a period of a beginning part of the selected subframe.

The control information contains information regarding a time length required for the transmission of the packet by broadcast from the base station apparatus (hereinafter this time length will be referred to as “road-to-vehicle transmission period”). The terminal apparatus identifies the road-to-vehicle period based on the control information, and transmits the packet in a period other than the road-to-vehicle transmission period. Since in this manner the road-to-vehicle communication and the inter-vehicular communication are subjected to time-division multiplexing, the collision probability of packets in between the road-to-vehicle communication and the inter-vehicular communication can be reduced. In other words, since the terminal apparatus recognizes the content of the control information, the interference between the road-to-vehicle communication and the inter-vehicular communication is reduced. An area where a terminal apparatus, which is executing the inter-vehicular communication, is located is classified into three kinds.

One of the three kinds of areas is an area formed around the base station (hereinafter referred to as “first area”). Another one is an area outside the first area (hereinafter referred to as “second area”). Still another one is an area formed outside the second area (hereinafter referred to as “outside-the-second-area” also). Here, in the first and second areas, the packets sent from the base station apparatus can be received, with a certain admissible quality, by terminal apparatuses. However, in the outside-the-second-area, which is an area outside the second area, the packets sent from the base station apparatus is not receivable, with a certain admissible quality, by terminal apparatuses. The first area is formed such that the first area is formed closer to the center of the intersection than the second area is. Since a vehicle located in the first area is located close to the vicinity of the intersection, the packets sent from the terminal apparatus mounted on the vehicle is said to be important information in terms of preventing the collision accidents.

As a result of the aforementioned definitions of those areas, a time length required for the inter-vehicular communication (hereinafter referred to as “inter-vehicular period”) is formed by the time-division multiplexing of a priority period and a general period. The priority period is a period used by a terminal apparatus located in the first area, and such a terminal apparatus transmits a packet by using any of a plurality of slots that form the priority period. The general period is a period used by a terminal apparatus located in the second area, and such a terminal apparatus transmits a packet, using a CSMA scheme. The terminal apparatus mounted on the vehicle determines which area the current location of the terminal apparatus belongs to. Depending on the base station apparatus, the first area may not be formed at all. In such a case, the inter-vehicular period will be formed by the general period only.

In other words, two kinds of frame construction are defined. The base station apparatus conveys the information on a frame in use to the terminal apparatuses by the packet broadcast during the road-to-vehicle transmission period. The construction of a frame that does not contain the priority period (hereinafter referred to as “first frame”) is simpler than that of a frame that contains the priority period (hereinafter referred to as “second frame”), so that the information amount of control information can be reduced. In the base station apparatus according to the present exemplary embodiment, in order to simplify the construction of control information, the information on the road-to-vehicle transmission period is added to the packet if the first frame is used, whereas the information on the priority period is added to the packet if the second frame is used.

Since a terminal apparatus located in the outside-the-second-area is not aware of the frame construction, this terminal apparatus transmits the packet, using the CSMA scheme, regardless of the frame construction. In order to reduce the probability of collision with packets transmitted by broadcast from the other terminal apparatuses, it is desirable that even in this case, the packet is transmitted by broadcast in any of a plurality of slots contained in a frame. This is because the situation where the collision occurs in the middle of a packet is less likely to occur if the packet is transmitted on a packet-by-packet basis. In order to cope with this, the terminal apparatus according to the present exemplary embodiment, if it is located in the outside-the-second-area, receives the packet which has been transmitted by broadcast from the other terminal apparatuses and which has been transmitted by broadcast in any of the slots. The terminal apparatus synchronizes with the frame, based on the received packet. The terminal apparatus transmits, by broadcast, the packet using any of the plurality of slots in the frame.

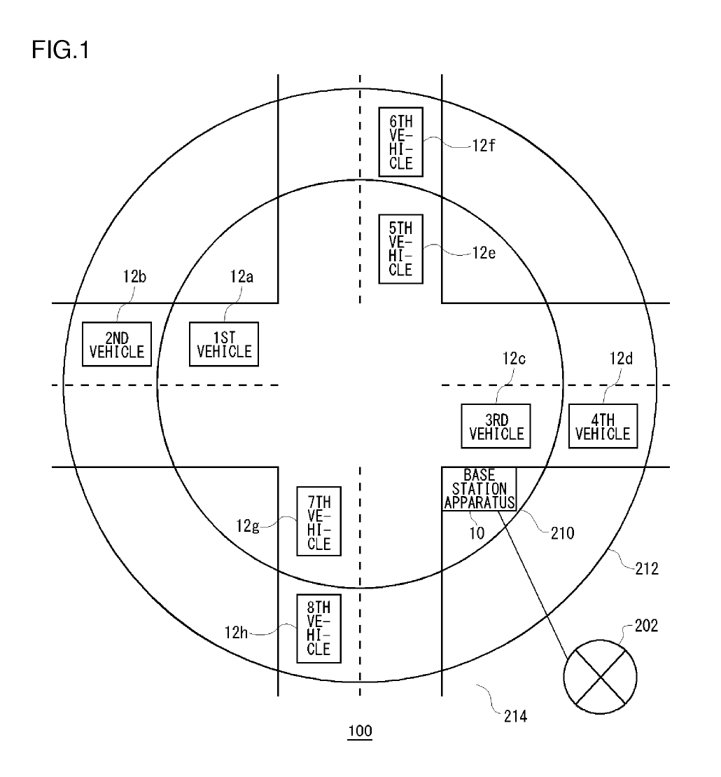

FIG. 1 shows a structure of a communication system 100 according to an exemplary embodiment of the present invention. FIG. 1 corresponds to a case thereof at an intersection viewed from above. The communication system 100 includes a base station apparatus 10, a first vehicle 12a, a second vehicle 12b, a third vehicle 12c, a fourth vehicle 12d, a fifth vehicle 12e, a sixth vehicle 12f, a seventh vehicle 12g, and an eighth vehicle 12h, which are generically referred to as “vehicle 12” or “vehicles 12”, and a network 202. It is to be noted that each vehicle 12 has a not-shown terminal apparatus mounted therein. Also, the first area 210 is formed around the base station apparatus 10, the second area 212 is formed outside the first area, and the outside-the-second-area 214 is formed outside the second area 212.

As shown in FIG. 1, a road extending in the horizontal, or left-right, direction and a road extending in the vertical, or up-down, direction in FIG. 1 intersect with each other in the central portion thereof. Note here that the upper side of FIG. 1 corresponds to the north, the left side thereof the west, the down side thereof the south, and the right side thereof the east. And the portion where the two roads intersect each other is the intersection. The first vehicle 12a and the second vehicle 12b are advancing from left to right, while the third vehicle 12c and the fourth vehicle 12d are advancing from right to left. Also, the fifth vehicle 12e and the sixth vehicle 12f are advancing downward, while the seventh vehicle 12g and the eighth vehicle 12h are advancing upward.

In the communication system 100, the base station apparatus 10 is installed at the intersection. The base station apparatus 10 controls communications between the terminal apparatuses. The base station apparatus 10 repeatedly generates a frame containing a plurality of subframes, based on the signal received from not-shown GPS satellites and frames formed by the other base station apparatuses 10 (not-shown). Here, a definition is made such that the road-to-vehicle transmission period can be set to the leading part of each subframe. The base station apparatus 10 selects a subframe, in which the road-to-vehicle transmission period is not set by the other base station apparatuses 10, from among a plurality of subframes. The base station apparatus 10 sets the road-to-vehicle transmission period to the beginning part of the selected subframe. The base station apparatus 10 broadcasts the packet in the thus set road-to-vehicle transmission period.

It is assumed that there are a plurality of kinds of data as data to be contained in the packet. One of the data is data such as traffic jam information and road repairing information, whereas another one of the data is data concerning each slot contained in the priority period. The latter one includes a slot, which is not used by any terminal terminals (hereinafter referred to as “empty slot” or “unused slot”), a slot used by a single terminal apparatus (hereinafter referred to as “in-use slot” or “slot in use”), and a slot used by a plurality of terminal apparatuses (hereinafter referred to as “collision slot”). A packet containing the data such as the traffic jam information and the road repairing information (hereinafter referred to as “RSU packet”) and a packet containing the data concerning each slot (hereinafter referred to as “control packet”) are produced separately from each other. The RSU packet and the control packet will be generically referred to as “packet”.

The first area 210 and the second area 212 are formed around the communication system 100 according to the receiving status of the packets received from the base station apparatus 10. As shown in FIG. 1, the first area 210 is located near the base station apparatus 10 as an area where the receiving status is comparatively satisfactory. The first area 210 may be said to be formed in the center of the intersection. On the other hand, the second area 212 is formed outside the first area 210 as an area where the receiving status is more degraded than or less satisfactory than the first area 21. Further, the outside-the-second-area 214 is formed outside the second area 212 as an area where the receiving status is further degraded than the second area 212. Note that the error rate and the received power of a packet are used as the receiving status.

A packet contains two kinds of control information. One is information regarding a road-to-vehicle transmission period that has been set (hereinafter referred to as “basic part”), whereas the other is information on a priority period that has been set (hereinafter referred to as “extended part”). A terminal apparatus produces a frame based on the basic part contained in the received packet. As a result, frames generated respectively by a plurality of terminal apparatuses are synchronized with a frame generated by the base station apparatus 10. Each terminal apparatus receives the packet broadcast by the base station apparatus 10 and estimates its location, which belongs to one of the first area 210, the second area 212, and the outside-the-second-area 214, based on the receiving status of the received packet. If it is located in the first area 210, the terminal apparatus will broadcast the packet to any of slots contained in the priority period. If it is located in the second area 212, the terminal apparatus will broadcast the packet in the general period with carrier sensing. Accordingly, TDMA is executed in the priority period, and CSMA/CA is executed in the general period.

In the next frame, too, the terminal apparatus selects the same subframe in corresponding timing. In the priority period, in particular, the terminal apparatus selects the same slots in corresponding timing in the next frame. At this time, the terminal apparatus acquires data and stores the data in the packet. For example, the information regarding the present location is contained in the data. The terminal apparatus also stores the control information in the packet. In other words, the control information transmitted from the base station apparatus 10 is transferred by the terminal apparatus. If, on the other hand, it is estimated that the terminal apparatus is located in the outside-the-second-area 214 and if the terminal apparatus can receive the packets, which have been broadcast from the other terminal apparatuses and have also been broadcast using any of slots contained in the priority period, the terminal apparatus will generate frames based on these packets. Also, the terminal apparatus randomly selects any of slots contained in the priority period of the frame and broadcasts the selected slot by the packet. If the terminal apparatus cannot receive the packets, which have been broadcast from the other terminal apparatuses and have also been broadcast using any of slots contained in the priority period, the terminal apparatus will execute CSMA/CA regardless of the frame construction and thereby broadcast the packets.

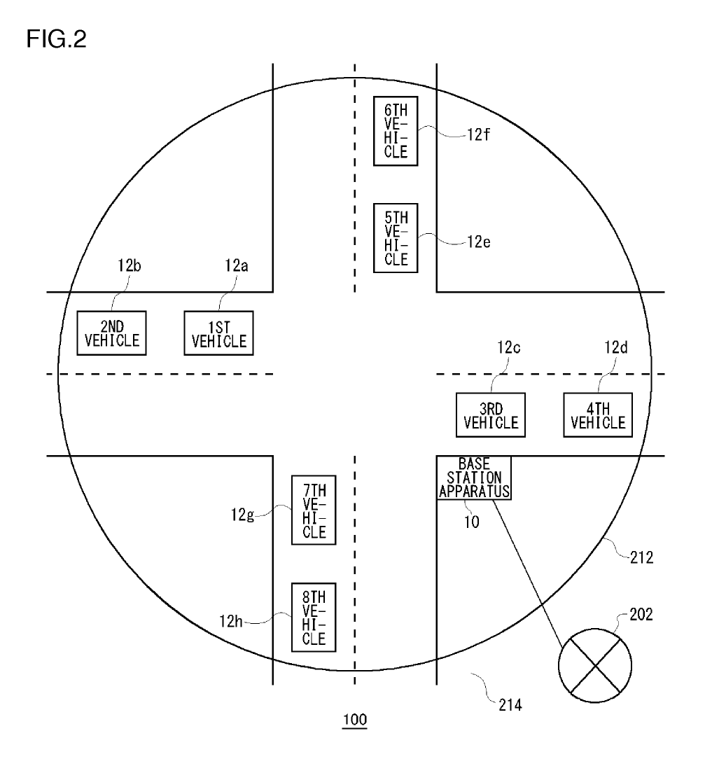

FIG. 2 shows another structure of the communication system 100 according to an exemplary embodiment of the present invention. Though the communication system 100 of FIG. 2 is configured similarly to FIG. 1, the first area 210 is not formed. Assume, for example, that the intersection of FIG. 2 differs from the intersection of FIG. 1. In the case of FIG. 2, the inter-vehicular transmission period does not contain the priority period but the general period only. In this case, the control packet is no longer necessary as the packet sent from the base station apparatus 10, and the RSU packets only are broadcast. Also, the extended part is no longer necessary in the control information, and the basic part only is contained therein. In other words, where the first frame is used as in FIG. 2, a part of a plurality of packets broadcast in the road-to-vehicle transmission period is broadcast and a part of the control signal is contained in the packet as compared with the case where the second frame is used as in FIG. 1. In this case, whether the base station apparatus is the base station apparatus 10 of FIG. 1 or the base station apparatus of FIG. 2 is set by a telecommunications carrier.

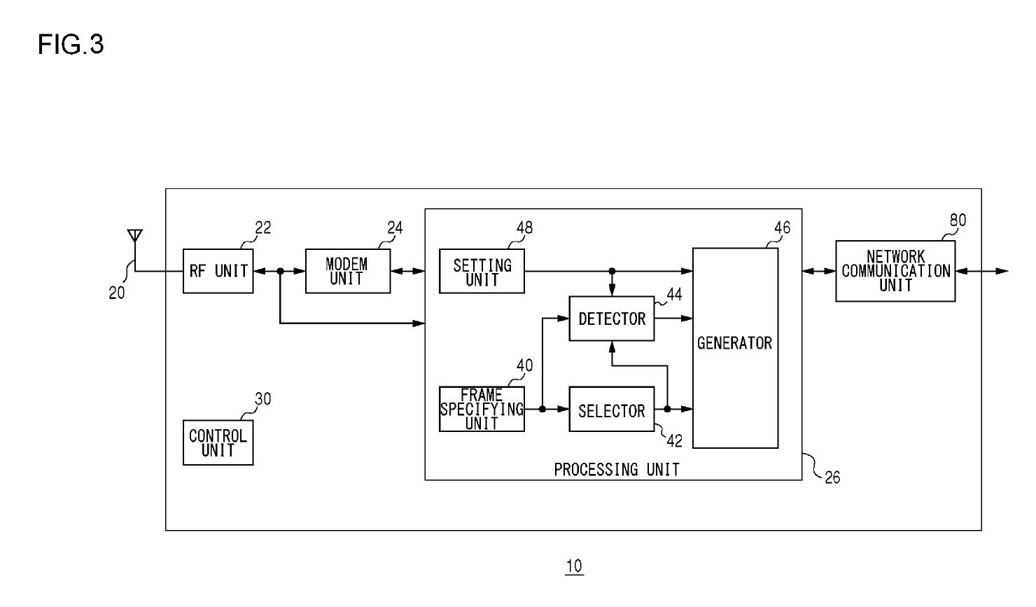

FIG. 3 shows the base station apparatus 10. The base station apparatus 10 includes an antenna 20, an RF unit 22, a modem unit 24, a processing unit 26, a control unit 30, and a network communication unit 80. The processing unit 26 includes a frame specifying unit 40, a selector 42, a detector 44, a generator 46, and a setting unit 48. As a receiving processing, the RF unit 22 receives, through the antenna 20, packets transmitted from terminal apparatuses and the other base station apparatuses (not shown). The RF unit 22 performs a frequency conversion on the received packet of a radiofrequency and thereby generates a packet of baseband. Further, the RF unit 22 outputs the baseband packet to the modem unit 24. Generally, a baseband packet is formed of an in-phase component and a quadrature component, and therefore it should be represented by two signal lines. However, it is represented by a single signal line here to make the illustration clearer for understanding. The RF unit 22 also includes an LNA (Low Noise Amplifier), a mixer, an AGC (Automatic Gain control) unit, and an A/D converter.

As a transmission processing, the RF unit 22 performs a frequency conversion on the baseband packet inputted from the modem unit 24 and thereby generates a radiofrequency packet. Further, the RF unit 22 transmits, through the antenna 20, the radiofrequency packet in a road-to-vehicle transmission period. The RF unit 22 also includes a PA (Power Amplifier), a mixer, and a D-A converter.

As a receiving processing, the modem unit 24 demodulates the radiofrequency packet fed from the RF unit 22. Further, the modem unit 24 outputs the demodulation result to the processing unit 26. As a transmission processing, the modem unit 24 modulates the data fed from the processing unit 26. Further, the modem unit 24 outputs the modulation result to the RF unit 22 as a baseband packet. It is to be noted here that the communication system 100 is compatible with the OFDM (Orthogonal Frequency Division Multiplexing) modulation scheme and therefore the modem unit 24 performs FFT (Fast Fourier Transform) as a receiving processing and performs IFFT (Inverse Fast Fourier Transform) as a transmission processing also.

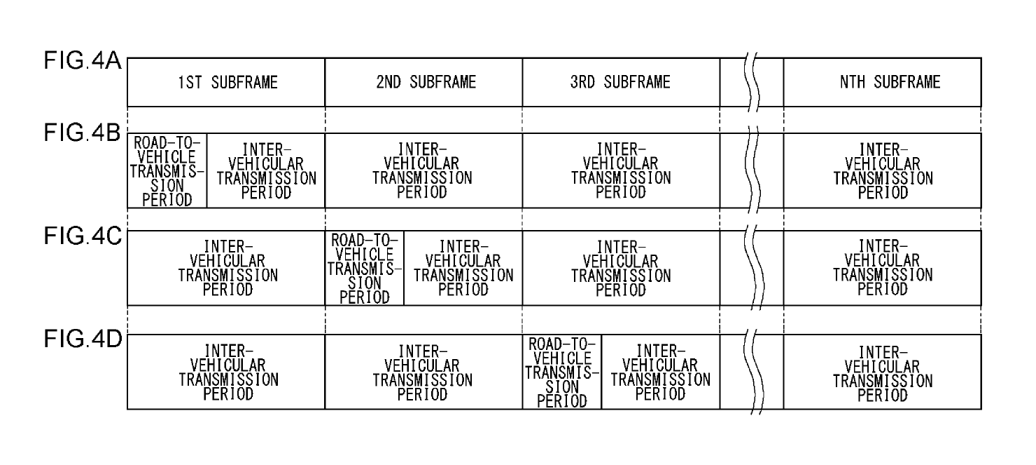

The frame specifying unit 40 receives signals from the not-shown GPS satellites and acquires information on the time of day based on the received signals. It should be noted that known art can be used for the acquisition of information on the time of day and therefore the description thereof is omitted here. The frame specifying unit 40 generates a plurality of frames based on the information on the time of day. For example, the frame specifying unit 40 generates ten “100 msec” frames by dividing a duration of “1 sec” into 10 parts starting from the timing indicated by the information on the time of day. Frames are thus defined and specified repeatedly through the repetition of this process. Note that the frame specifying unit 40 may detect the control information from the demodulation result and generate frames based on the detected control information. Such a processing as this corresponds to generating a frame synchronized with the timing of the frames formed by the other base station apparatuses 10. FIGS. 4A to 4D each shows a format of frame specified in the communication system 100. FIG. 4A shows a structure of each frame. Each frame is formed of N subframes denoted by a first subframe to an Nth subframe. For example, when each frame is 100 msec long and N is 8, the subframe of 12.5 msec in length (duration) is defined. A description of FIGS. 4B to 4D will be given later. Now, refer back to FIG. 3.

The selector 42 selects a subframe, with which to set the road-to-vehicle transmission period, from among a plurality of subframes contained in a frame. More to the point, the selector 42 receives a frame defined by the frame specifying unit 40. The selector 42 receives the input of demodulation results from the not-shown other base station apparatuses 10 or other terminal apparatuses via the RF unit 22 and the modem unit 24. The selector 42 extracts the demodulation result sent from the other base station apparatuses 10 from among the demodulation results inputted. A method of how to extract the demodulation result will be discussed later. The selector 42 identifies a subframe, which does not receive the demodulation result, by identifying the subframe that has received the demodulation result.

This corresponds to identifying an unused subframe, namely, a subframe to which the road-to-vehicle transmission period is not set by the other base station apparatuses 10. If there are a plurality of unused subframes, the selector 42 will randomly select a single subframe. If there is no unused subframes, namely, if a plurality of subframes are all used respectively, the selector 42 will acquire the received power corresponding to the demodulation result and select preferentially a subframe whose received power is small.

FIG. 4B shows a structure of a frame generated by a first base station apparatus 10a. The first base station apparatus 10a sets a road-to-vehicle transmission period at the beginning of the first subframe. Subsequent to this road-to-vehicle transmission period, the first base station apparatus 10a sets an inter-vehicular transmission period in the first subframe. The inter-vehicular transmission period is a period during which a terminal apparatus can broadcast a packet. In other words, the subframes are defined such that the first base station apparatus 10a can broadcast the packet in the road-to-vehicle transmission period assigned to the beginning of the first subframe and such that the terminal apparatus can broadcast the packet in the inter-vehicular transmission period, other than the road-to-vehicle transmission period, in each frame. Further, the first base station apparatus 10a sets only the inter-vehicular periods to the second to Nth subframes.

FIG. 4C shows a structure of a frame generated by a second base station apparatus 10b. The second base station apparatus 10b sets a road-to-vehicle transmission period at the beginning of the second subframe. The second base station apparatus 10b sets an inter-vehicular transmission period to the subsequent remaining period of the second subframe, and sets only the inter-vehicular frames to the first subframe, the third to Nth subframes. FIG. 4D shows a structure of a frame generated by a third base station apparatus 10c. The third base station apparatus 10c sets a road-to-vehicle transmission period at the beginning of the third subframe. The third base station apparatus 10c sets an inter-vehicular transmission period to the subsequent remaining period of the third subframe, and sets only the inter-vehicular frames to the first and second subframes and the fourth to Nth subframes. In this manner, a plurality of base station apparatuses 10 select mutually different subframes and set the road-to-vehicle transmission periods at the beginnings of the selected subframes, respectively. Now, refer back to FIG. 3. The selector 42 outputs the selected subframes to the detector 44 and the generator 46.

The setting unit 48 has an interface used to receive instructions given from the telecommunications carrier, and receives instructions by which to set parameters via the interface. For example, the interface may be buttons, and the setting unit 48 receives the parameter setting instructions through the input to the buttons. Also, the interface may be connection terminals to the network communication unit 80 described later. In such a case, the setting unit 48 receives the parameter setting instructions via the not-shown network 202 and a PC. The parameter setting instruction is an instruction as to whether the first frame is to be used or the second frame is to be used. The setting unit 48 outputs the received setting instruction to the detector 44 and the generator 46.

The detector 44 receives instructions from the setting unit 48. If the setting instruction relates to the use of a first frame, the process will not be carried out. If the setting instruction relates to the use of a second frame, the detector 44 will identify if each of a plurality of slots contained in the priority period is (i) unused, (ii) in use, or (iii) in collision. The construction of subframe will be explained herein before a description is given of the processing performed by the detector 44.

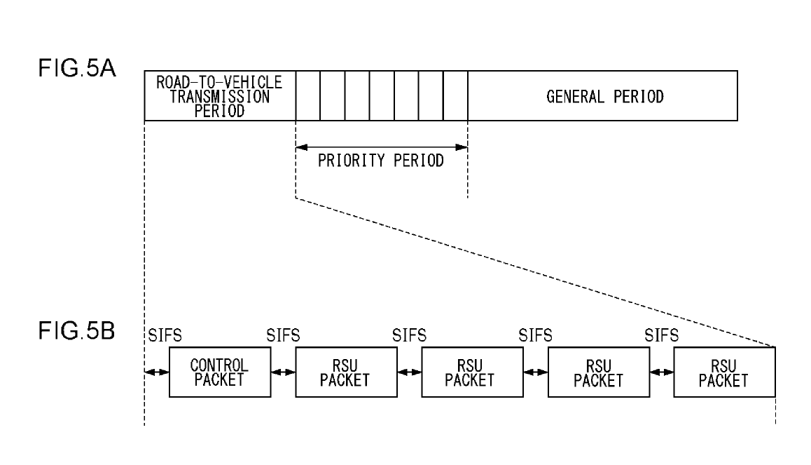

FIGS. 5A and 5B each shows a structure of subframe. This corresponds to a subframe defined in the base station apparatus 10 of FIG. 1, namely, a subframe when a second frame is used. As shown in FIG. 5A, each subframe is constituted of a road-to-vehicle transmission period, a priority period, and a general period in this order. In the road-to-vehicle transmission period, the base station apparatus 10 broadcasts a packet. The priority period is formed by time-division multiplexing a plurality of slots, and the terminal apparatus 14 can broadcast a packet using each slot. The general period has a predetermined length, and the terminal apparatus 14 can broadcast a packet in the general period. The priority period and the general period correspond to the inter-vehicular transmission period of FIG. 4B, for example. If the road-to-vehicle transmission period is not contained in the subframe, the subframe is constituted of a priority period and a general period in this order. In this case, the road-to-vehicle transmission period is part of the priority period. It should be noted here that the general period may also be formed by time-division multiplexing a plurality of slots. FIG. 5B will be described later. Now, refer back to FIG. 3.

The detector 44 measures not only the received power for each slot but also the error rate for each slot. One example of the error rate is a bit error rate (BER). If the received power is lower than a threshold for the received power, the detector 44 will determine that the slot is unused (hereinafter such a slot will be referred to as “empty slot” or “unused slot”). If, on the other hand, the received power is greater than or equal to the threshold for the received power and if the error rate is lower than a threshold for the error rate, the detector 44 will determine that the slot is in use (hereinafter such a slot will be referred to as “in-use slot”). If the received power is greater than or equal to the threshold for the received power and if the error rate is greater than or equal to the threshold for the error rate, the detector 44 will determine that collision occurs in the slot (hereinafter such a slot will be referred to as “collision slot”). The detector 44 performs all these processing on the slots and outputs these results (hereinafter referred to as “detection results” or “detection result”) to the generator 46.

The generator 46 receives the setting instruction fed from the setting unit 48 and receives the numbers assigned to the subframes. If the setting instruction relates to the use of a second frame, the generator 46 will receive the detection results from the detector 44. A description is first given of a case where the setting instruction relates to the use of a second frame. The generator 46 sets the road-to-vehicle transmission period to the subframe that corresponds to the received subframe number, and generates a control packet and RSU packets to be broadcast in the road-to-vehicle transmission period. FIG. 5B shows an arrangement of packet in the road-to-vehicle transmission period. As shown in FIG. 5B, one control packet and a plurality of RSU packets are arranged in the road-to-vehicle transmission period. It should be noted here that the previous and next packets are separated by a short interframe space (SIFS). Now, refer back to FIG. 3.

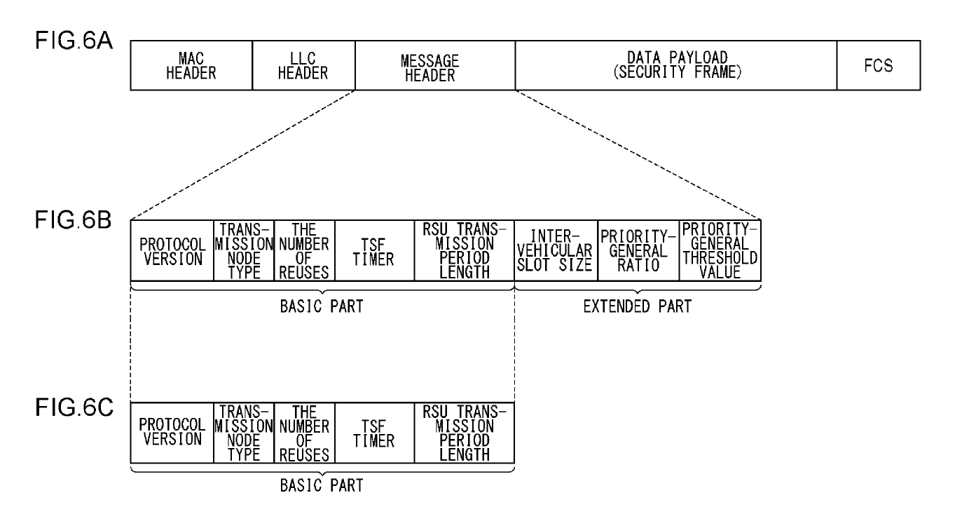

A description is given here of a structure of control packet and RSU packet. FIGS. 6A to 6C each shows a format of MAC (Message Authentication Code) frame stored in a packet defined in the communication system 100. FIG. 6A shows a format of MAC frame. The MAC frame is such that “MAC header”, “LLC header”, “message header”, “data payload”, and “FCS” are assigned in this order starting from the beginning. The MAC header, the LLC header, and the message header store information concerning data communication control, and the respective headers correspond to the respective layers of communication layer. Each feed length is as follows, for instance. The MAC header is 30 byte long, the LLC header 8 byte long, and the information header 12 byte long. If the data payload contains the detection results, a packet that stores this MAC frame will correspond to the control packet. If the generator 46 receives data, such as traffic jam information and road repairing information, from the network communication unit 80, the generator 46 will add these data to the data payload. The packet that stores such MAC frame corresponds to the RSU packet. Note here that the network communication unit 80 connects to the not-shown network 202. The packets broadcast in the priority period and the general period also store MAC frames as shown in FIG. 6A. The data payload corresponds to a security frame described later.

FIG. 6B is a diagram showing a structure of message header generated by the generator 46 when a second frame is to be used. The message header includes a basic part and an extended part. Since, as described earlier, the structure of the control packet is the same as that of the RSU packet, both the control packet and the RSU packet, broadcast when the second frame is used, contain the basic parts and the extended parts. The basic part includes “protocol version”, “transmission node type”, “the number of reuses”, “TSF timer”, and “RSU transmission period length”. The extended part includes “inter-vehicular slot size”, “priority-general ratio”, and “priority-general threshold”.

The protocol version indicates a version of compatible protocol and also contains identification by which to identify that the message head contains the basic part only or that the message header contains the basic part and the extended part. The former corresponds to FIG. 6C, whereas the latter corresponds to FIG. 6B. The identifier of the former is “0”, and the identifier of the latter is “1”. The transmission node type indicates a sender of packet that contains the MAC frame. For example, “0” indicates a terminal apparatus, and “1” indicates the base station apparatus 10. When the selector 42 extracts the demodulation results sent from the other base station apparatuses 10 from the inputted demodulation results, the selector 42 utilizes the value of the transmission node type.

The number of reuses indicates an index of validity in the case when the header message is transferred by the terminal apparatus. TSF timer indicates the transmission time. The RSU transmission period length indicates the time length of road-to-vehicle transmission period and therefore the RSU transmission period is said to serve as the information regarding the road-to-vehicle transmission period. The inter-vehicular slot size indicates the size of slot(s) contained in the priority period. The priority-general ratio indicates a ratio between the priority period and the general period. The priority-general threshold is a threshold according to which the terminal apparatus 14 selects either the use of priority period or the use of general period, and the priority-general threshold is also a threshold for the received power. That is, the extended part corresponds to the information on the priority period and the general period. FIG. 6C will be discussed later. Now, refer back to FIG. 3.

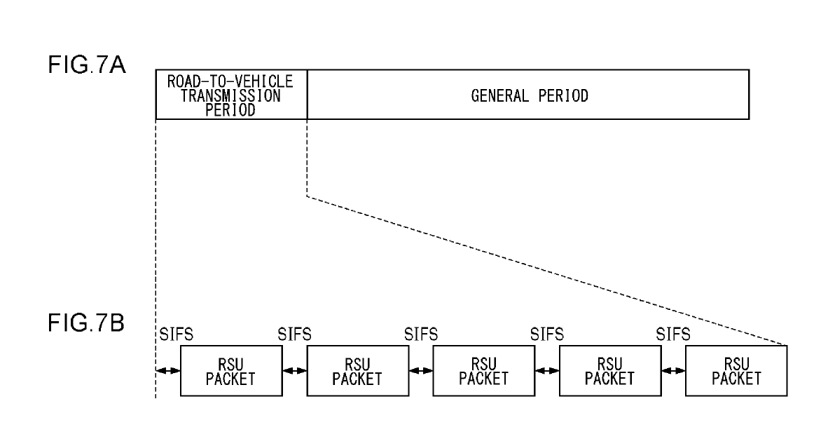

A description is now given of a case where the setting instruction relates to the use of a first frame. The generator 46 sets the road-to-vehicle transmission period to the subframe that corresponds to the received subframe number, and generates a control packet and RSU packets to be broadcast in the road-to-vehicle transmission period. It should be noted here that the control packet is not generated. FIGS. 7A and 7B each shows another structure of subframe. FIG. 7A corresponds to a subframe defined in the base station apparatus 10 of FIG. 2, namely, a subframe when a first frame is used. As shown in FIG. 7A, each subframe is constituted of a road-to-vehicle transmission period and a general period in this order. FIG. 7B shows an arrangement of packet in the road-to-vehicle transmission period. As shown in FIG. 7B, a plurality of RSU packets are arranged in the road-to-vehicle transmission period but there are no control packets. It should be noted here that the previous and next packets are separated by a short interframe space (SIFS). Now, refer back to FIG. 3.

FIG. 6C shows a structure of message header when the first frame is used. As shown in FIG. 6C, the generator 46 generates a basic part without producing the extended part. The information contained in the basic part is the same regardless of whether the first frame or the second frame is used. Now, refer back to FIG. 3. These are summarized as follows: when the first frame is used, the generator 46 has the basic part contained in the RSU packet.

The processing unit 26 transmits, by broadcast, the packet to the modem unit 24 and the RF unit 22 in the road-to-vehicle transmission period. That is, when the first frame is used, the processing unit 26 transmits, by broadcast, the RSU packet containing the basic part in the road-to-vehicle transmission period; when the second frame is used, the processing unit 26 transmits, by broadcast, the control packet and RSU packet both containing the basic part and the extended part. The control unit 30 controls the entire processing of the base station apparatus 10.

These structural components may be implemented hardwarewise by elements such as a CPU, memory and other LSIs of an arbitrary computer, and softwarewise by memory-loaded programs or the like. Depicted herein are functional blocks implemented by cooperation of hardware and software. Therefore, it will be obvious to those skilled in the art that the functional blocks may be implemented by a variety of manners including hardware only, software only or a combination of both.

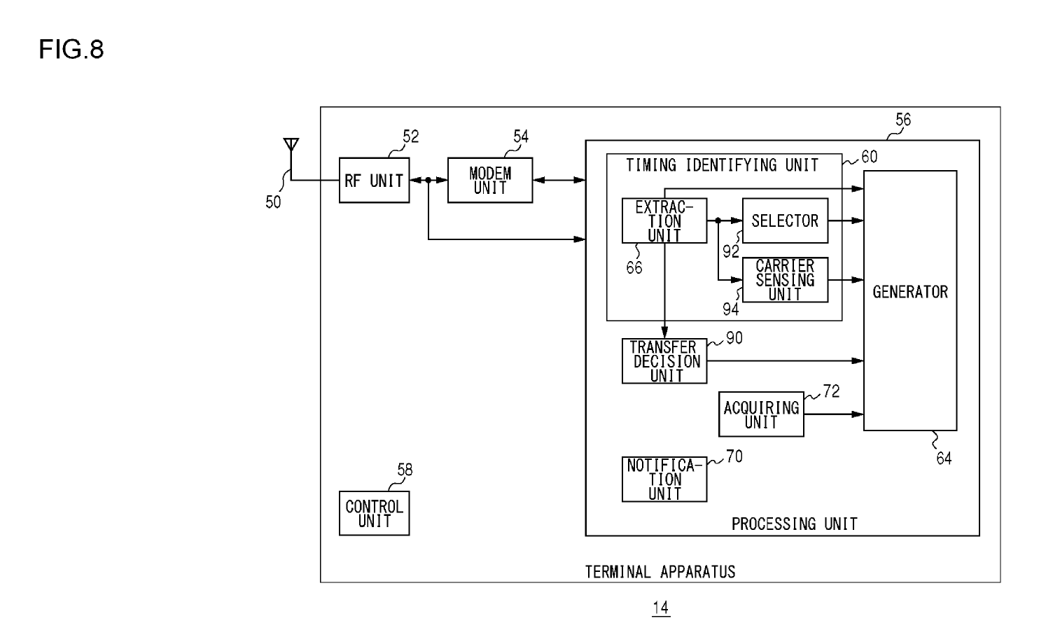

FIG. 8 shows a structure of a terminal apparatus 14 mounted on a vehicle 12. The terminal apparatus 14 includes an antenna 50, an RF unit 52, a modem unit 54, a processing unit 56, and a control unit 58. The processing unit 56 includes a generator 64, a timing identifying unit 60, a transfer decision unit 90, a notification unit 70, and an acquiring unit 72. The timing identifying unit 60 includes an extraction unit 66, a selector 92, and a carrier sensing unit 94. The antenna 50, the RF unit 52, and the modem unit 54 perform the processings similar to those of the antenna 20, the RF unit 22, and the modem unit 24 of FIG. 3, respectively. A description is therefore given here centering around features different from those of FIG. 3.

The modem unit 54 and the processing unit 56 receive the packets sent from the not-shown other terminal apparatuses 14 and the base station apparatus 10. As described earlier, the modem unit 54 and the processing unit 56 receive the packet, sent from the base station apparatus 10, in the road-to-vehicle transmission period. As described earlier, when the first frame is used, the modem unit 54 and the processing unit 56 receive the packets, sent from the other terminal apparatuses 14, in the general period; when the second frame is used, the modem unit 54 and the processing unit 56 receive the packets, sent from the other terminal apparatuses 14, in the priority frame and the general period.

When the demodulation result relates to the packet sent from the not-shown base station apparatus 10, the extraction unit 66 identifies the timing of a subframe assigned to the road-to-vehicle transmission period. Also, the extraction unit 66 generates frames based on the timing of the subframe and a content of the basic part in the message header of the packet (more specifically, a content of the RSU transmission period length). Since the frames may be generated similarly to the aforementioned frame specifying unit 40, the description thereof is omitted here. As a result, the extraction unit 66 generates a frame synchronized with the timing of the frame formed by the base station apparatus 10.

If it is detected that the control packet and the RSU packet(s) are received in the road-to-vehicle transmission period or if it is detected that the basic part and the extended part are contained in the message header of the received packet, the extraction unit 66 will recognize the use of the second frame. If, on the other hand, it is detected that the RSU packet(s) only is/are received in the road-to-vehicle transmission period or if it is detected that the basic part only is contained in the message header of the received packet, the extraction unit 66 will recognize the use of the first frame.

If the extraction unit 66 recognizes the use of the second frame, the extraction unit 66 will measure the received power of the packet sent from the base station apparatus 10. Based on the measured received power, the extraction unit 66 estimates if its own terminal apparatus is located in the first area 210, the second area 212, or the outside-the-second-area 214. For example, the extraction unit 66 stores threshold(s) for area determination. The threshold for area determination corresponds to the aforementioned priority-general threshold. If the received power is larger than the threshold for area determination, the extraction unit 66 will determine that the terminal apparatus is located in the first area 210. If the received power is less than or equal to the threshold for area determination, the extraction unit 66 will determine that the terminal apparatus is located in the second area 212. If packets sent from the base station apparatus 10 are not received at all, the extraction unit 66 will determine that the terminal apparatus is located in the outside-the-second-area 214. It should be noted here that the error rate may be used in the place of the received power, and the received power and the error rate may be used in combination.

Based on the estimation result, the extraction unit 66 determines one of the priority period, the general period, and the timing unrelated to the frame construction as the transmission period. More specifically, as the extraction unit 66 estimates that its own terminal apparatus is located in the outside-the-second-area 214, the extraction unit 66 checks to see if packets, broadcast from the other terminal apparatuses 14, which are synchronized with the frame in the base station apparatus 10 are received. Such a packet is broadcast using at least one slot in the priority period. The extraction unit 66 generates a frame synchronized with the frame in the base station apparatus 10, based on the received packets. For example, the received packet contains information on the order of slots of the packet broadcast in the priority period. The extraction unit 66 generates the frame based on the timing with which the packet is received and the information on the order of slots. The extraction unit 66 outputs the information on the thus generated frame to the selector 92.

If, on the other hand, the packets, broadcast from the other terminal apparatuses 14, which are synchronized with the frame in the base station apparatus 10 are not received, the extraction unit 66 will select the timing unrelated to the frame construction. As the extraction unit 66 selects the timing unrelated to the frame construction, the extraction unit 66 carries out carrier sensing and gives an instruction to the carrier sensing unit 94. If it is estimated that the terminal apparatus is located in the second area 212 or if the use of the first frame is detected, the extraction unit 66 will select the general period. If it is estimated that the terminal apparatus is located in the first area 210, the extraction unit 66 will select the priority period. If the priority period is selected, the extraction unit 66 will output the detection result contained in the data payload of the control packet to the selector 92. If the general period is selected, the extraction unit 66 will output the timings of frame and subframes and the information on the inter-vehicular transmission period to the carrier sensing unit 94.

The selector 92 receives the detection result from the extraction unit 66. As described earlier, the detection result indicates that each of a plurality of slots contained in the priority period is any one of three kinds of slots, which are an empty slot, an in-use slot, and a collision slot. The selector 92 selects any of the empty slots. If a slot has already been selected and if this slot is an in-use slot, the selector 92 will continue to select the same slot. If, on the other hand, a slot has already been selected and if this slot is a collision slot, the selector 92 will newly select an empty slot. If the information on the generated frame has been received from the extraction unit 66, the selector 92 will select at least one slot in the priority period of the frame. For example, the selector 92 randomly selects a slot. The selector 92 conveys the information on the selected slot to the generator 64 as the transmission timing.

The carrier sensing unit 94 receives the timing of frame and subframes and the information on the inter-vehicular transmission period. The carrier sensing unit 94 measures an interference power by performing carrier sensing in the general period. Also, the carrier sensing unit 94 determines the transmission timing in the general period, based on the interference power measured. More specifically, the carrier sensing unit 94 stores beforehand a predetermined threshold and compares the interference power against the threshold. If the interference power is smaller than the threshold, the carrier sensing unit 94 will determine the transmission timing. If the execution of carrier sensing is instructed from the extraction unit 66, the carrier sensing unit 94 will execute CSMA without regard to the frame construction and thereby determine the transmission timing. The carrier sensing unit 94 conveys the thus determined transmission timing to the generator 64.

The acquiring unit 72 includes a GPS receiver, a gyroscope, a vehicle speed sensor, and so forth all of which are not shown. The acquiring unit 72 acquires the present position, traveling direction, traveling speed and so forth of a not-shown vehicle 12, namely the vehicle 12 carrying the terminal apparatus 14, based on data supplied from the aforementioned not-shown components of the acquiring unit 72.

(Hereinafter the present position, traveling direction, traveling speed and so forth will be generically referred to as “positional information” or “position information”.) The present position thereof is indicated by the latitude and longitude. Known art may be employed to acquire them and therefore the description thereof is omitted here. The acquiring unit 72 outputs the positional information to the generator 64.

The transfer decision unit 90 controls the transfer of the message headers. The transfer decision unit 90 extracts the message headers from the packet. Where the packet is directly sent from the base station apparatus 10, the number of reuses is set to “0”. If the packet is sent from the other terminal apparatuses 14, the number of reuses will be set to “one or more”. The transfer decision unit 90 selects a message header to be transferred, from the extracted message headers. For example, a message header whose number of reuses is the minimum is selected. Also, the transfer decision unit 90 may generate a new message header by combining the contents contained in a plurality of message headers. The transfer decision unit 90 outputs the message header to be selected, to the generator 64. In so doing, the transfer decision unit 90 increases the number of reuses by “1”.

The generator 64 receives the positional information from the acquiring unit 72 and receives the message header sent from the transfer decision unit 90. The generator 64 uses the MAC frame shown in FIGS. 7A and 7B and stores the positional data in the data payload. The generator 64 generates a packets signal containing the MAC frame and transmits, by broadcast, the thus generated packet with the transmission timing determined by the selector 92 or the carrier sensing unit 94, via the modem unit 54, the RF unit 52, and the antenna 50. Note that the transmission timing is included in the inter-vehicular transmission period.

The notification unit 70 acquires the packet sent from the not-shown base station apparatus 10 in the road-to-vehicle transmission period and also acquires the packets sent from the not-shown other terminal apparatuses. As a process carried out for the acquired packet, the notification unit 70 conveys the approach or the like of the not-shown other vehicles 12 to the driver via a monitor or speaker according to the content of the data stored in the packet. The control unit 58 controls the entire operation of the terminal apparatus 14.

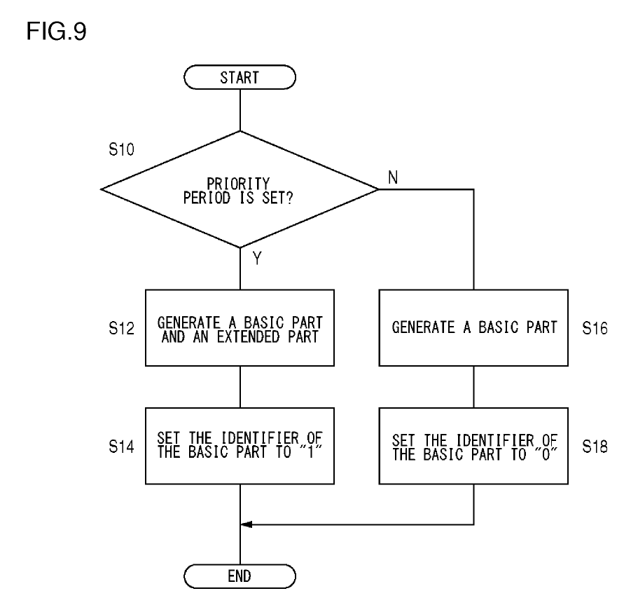

An operation of the communication system 100 configured as above is now described. FIG. 9 is a flowchart showing a procedure for generating a message header in the base station apparatus 10. If a priority period is set by the setting unit 48 (Y of S10), the generator 46 will generate a basic part and an extended part (S12). The generator 46 sets the identifier of the basic part to “1” (S14). If, on the other hand, the priority period is not set by the setting unit 48 (N of S10), the generator 46 will generate a basic part (S16). The generator 46 sets the identifier of the basic part to “0” (S18).

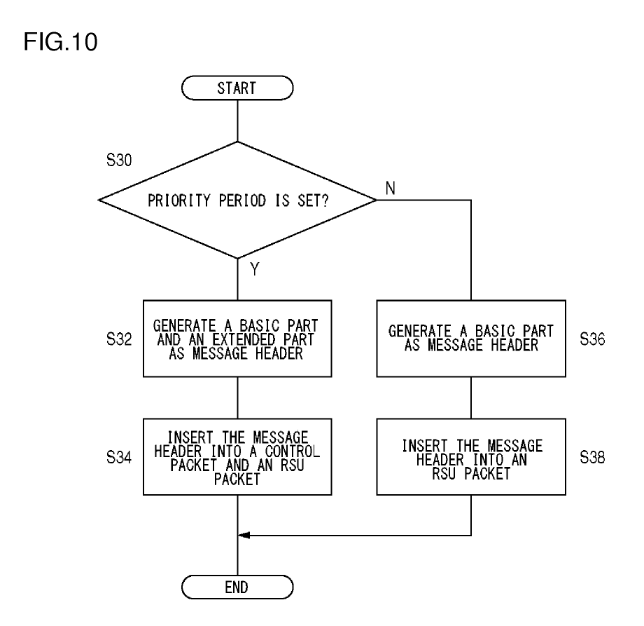

FIG. 10 is a flowchart showing a procedure for inserting a message header in the base station apparatus 10. If a priority period is set by the setting unit 48 (Y of S30), the generator 46 will generate a basic part and an extended part as a message header (S32). The generator 46 inserts the thus generated message header into the control packet and the RSU packet (S34). If, on the other hand, the priority period is not set by the setting unit 48 (N of S30), the generator 46 will generate a basic part as a message header (S36). The generator 46 inserts the thus generated message header into RSU packet (S38).

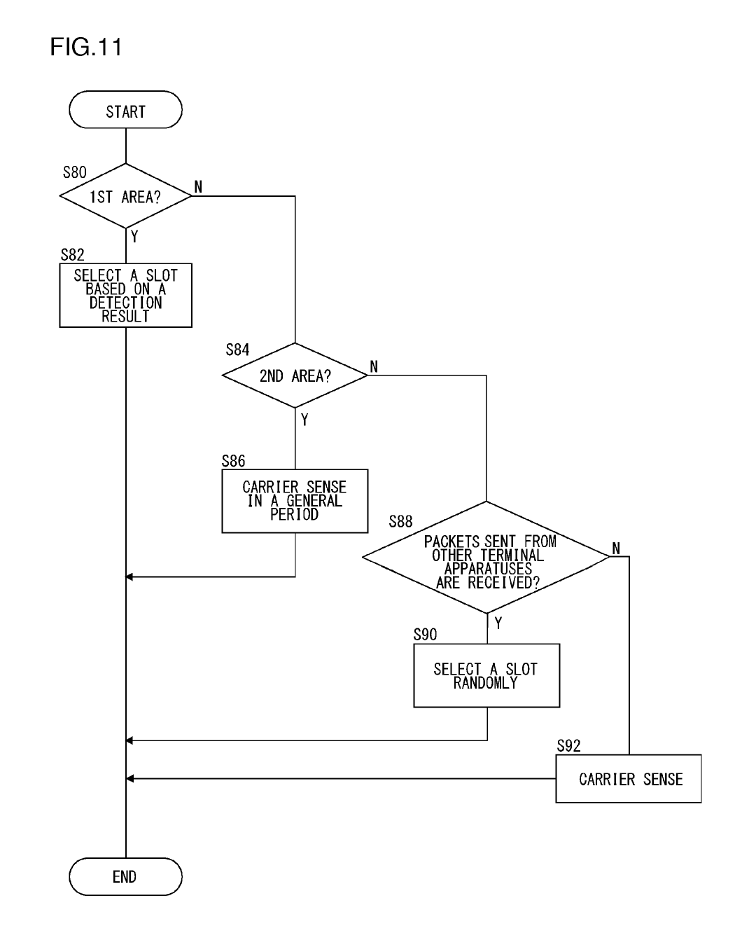

FIG. 11 is a flowchart showing a procedure for determining the broadcasting timing in the terminal apparatus 14. If the terminal apparatus 14 is located in the first area 210 (Y of S80), the selector 92 will select a slot based on the detection result (S82). If the terminal apparatus 14 is not located in the first area 210 (N of S80) but is located in the second area 212 (Y of S84), the carrier sensing unit 94 will carry out the carrier sensing in the general period (S86). If the terminal apparatus 14 is not located in the second area 212 (N of S84), namely, if it is located in the outside-the-second-area 214 and receives the packets sent from the other terminal apparatuses (Y of S88), the selector 92 will randomly select a slot (S90). If the terminal apparatus 14 is not receiving any packets sent from the other terminal apparatuses (N of S88), the carrier sensing unit 94 will carry out the carrier sensing (S92).

The wireless communications used in an intelligent transport system (ITS) are more susceptible to the interception of communications than the wired communications and therefore the wireless communications have difficulty in ensuring the secrecy of communication contents. Also, when equipment is to be controlled remotely via a network, an unauthorized action may possibly be taken by a fake third party. In order to secure the secrecy of communication contents in the wireless communications, it is required that the communication data be encrypted and the keys used for encryption be updated on a regular basis. When the key is to be updated for encryption, the transition of a plurality of states can be done easily if the unicast communication is premised. When the broadcast communication is to be used, it is difficult to use a common encryption key if there are terminal apparatuses of different states.

To prevent the spoofing and the like, digital signatures are used. An encryption key is used to generate a digital signature. In the communication system according to the present exemplary embodiment, a symmetric key in the symmetric key cryptosystem is used as an encryption key in consideration of the size of packet and the processing load in the inter-vehicular communication. At the same time, it is required in the road-to-vehicle communication that the spoofing and the like be further suppressed than in the inter-vehicular communication. For these purposes, in the road-to-vehicular communication, a public key and a private key in the public key cryptosystem are used for signatures, whereas a symmetric key in the symmetric key cryptosystem is used for data. Note that plural symmetric keys are used for the purpose of reducing the leakage risk of symmetric key. Each symmetric key is managed through each key ID, and plural symmetric keys are put altogether in a symmetric key table. Further, the version of a symmetric key table is managed through and as a table ID. Accordingly, each table ID contains a plurality of symmetric key IDs. It is desirable that such a symmetric key table be updated on a regular basis.

A description is first given herein of a processing performed in the inter-vehicular communication, and then a description is given of a processing performed in the road-to-vehicle communication. The inter-vehicular communication means communications performed between the terminal apparatuses by broadcast, whereas the road-to-vehicle communication means communications where the base station apparatus transmits, by broadcast, packets to the terminal apparatuses. Thus, the data broadcast by the inter-vehicular communication is also received by the base station apparatus. A packet to which a digital signature generated with a symmetric key in the symmetric key cryptosystem has been attached is broadcast from the terminal apparatus 14 of FIG. 1. The digital signature is a digital signature that is to be attached to an electromagnetic record such as data contained in the packet. This corresponds to a seal or signature in a paper document and is mainly used to authenticate a person's identity and to prevent the forgery and falsification. More specifically, when there is a person recorded in a document as a preparer of the document, whether the document is surely prepared by the person recorded in the document or not is certified, in the case of paper documents, by the signature or seal of the preparer. Since, however, the seal cannot be directly pressed against the electronic document or the signature cannot be written in the document, the digital signature serves its purpose of certifying this. To produce such digital signature, encryption is used.

In the symmetric key cryptosystem, the same value used for the encryption or a value easily derivable from the encryption key is used as a decryption key. A decryption key is known to a receiving-side terminal apparatus and therefore the certificate of the key is no longer required. As a result, the degradation of transmitting efficiency is suppressed as compared with when the public key cryptosystem is used. CBC-MAC (Cipher Block Chaining Message Authentication Code), CMAC (Cipher-based MAC), HMAC (Hash-based MAC) and the like are available as digital signature schemes. Also, the processing amount for the symmetric key cryptosystem is smaller than that for the public key cryptosystem. A typical method used for the symmetric key cryptosystem is DES (Data Encryption Standard) and AES (Advanced Encryption Standard). In the inter-vehicular communication, the symmetric key cryptosystem is used as the encryption scheme on account of the transmission load and the processing load.

If only a single type of symmetric key is used in the communication system 100, a malicious user may easily obtain the symmetric key. In order to cope with this, a plurality of symmetric keys are defined in advance in the communication system 100, and each symmetric key is managed through a symmetric key ID. Also, a plurality of symmetric keys are gathered together into a symmetric key table. Further, The symmetric key table is managed through the table IDs, and the symmetric key table is adapted to the version update by increasing the table IDs.

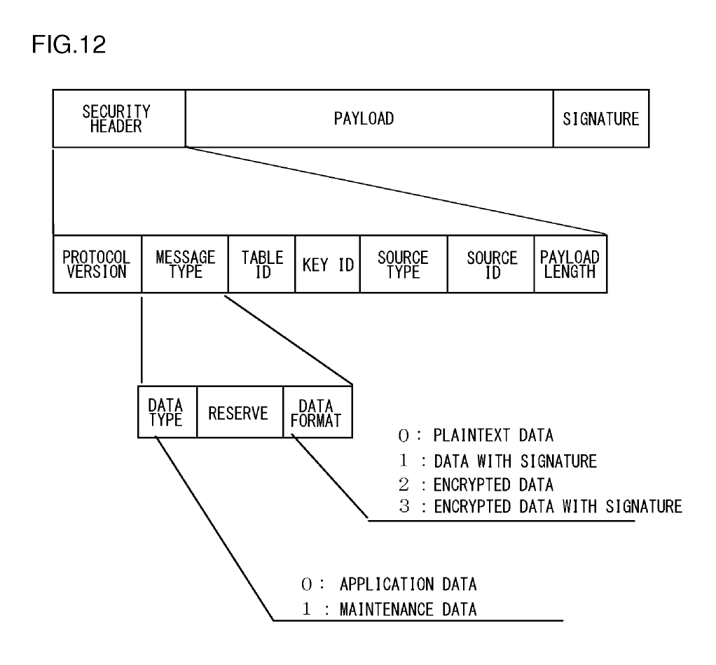

FIG. 12 shows a format of security frame of the inter-vehicular communication contained in the MAC frame of FIG. 6A. The security frame is constituted by “security header”, “payload”, and “signature”. The security header is constituted by “protocol version”, “message type”, “table ID”, “key ID”, “source type”, “source ID”, and “payload length”. Protocol version is identification information by which to specify the format of a security frame. The protocol version is a fixed value in the communication system 100. The message type includes “data type”, “data format”, and “reserve”. The data type sets the flag information defined as follows. The flag information identifies whether the data stored in the payload is application data(=0) or maintenance data(=1).

The data format is a format concerning the security of data stored in the payload, namely a flag that defines a process for encrypting the payload. Here, it is assumed that plaintext data(=0), data with signature(=1), encrypted data(=2), and encrypted data with signature(=3) are set. Note that “reserve” is a reserve for future use and will not be used by the communication system 100. A table ID is identification information used to identify a symmetric key table that contains a symmetric key used for the encryption of the digital signature or payload. A key ID is identification information by which a symmetric key used for the encryption of the digital signature or payload is identified, and corresponds to the aforementioned symmetric key ID. A source type ID sets the type of a sender of packets. That is, the source type ID is set to identify a base station apparatus 10(=3), a terminal apparatus(=2) mounted on an emergency vehicle (hereinafter referred to as “priority vehicle” also) such as a fire-extinguishing vehicle and an ambulance vehicle, a terminal apparatus(=1) mounted on other vehicles (hereinafter referred to as “ordinary vehicles” also), and a terminal apparatus(=0) mounted on a non-vehicle. Though not used in the inter-vehicular communication, a roadside unit(=3) is used when the base station apparatus 10 transmits in the road-to-vehicle communication. The source ID is unique identification information by which a base station apparatus 10 or a terminal apparatus 14 that has transmitted the packet can be uniquely identified.

The payload is a field used to store the aforementioned data, and corresponds to driving information and the like to be conveyed from the terminal apparatus 14 to the other terminal apparatuses. The signature is a digital signature for the security header and the payload. If the data format of the message type is data with signature(=1), a digital signature for the security header and the payload will be generated and its value will be substituted into the signature. When the data format of the message type is encrypted data(=2), the payload will be encrypted. When the data format of the message type is encrypted data with signature(=3), stored in the signature are a fixed value, a value identifiable at a receiving side, such as a copy of a security header portion, or a hash value (a computational result for a hash function) for a security header and/or a payload before encryption, and a computable value at a receiving side, such as checksum and parity. Then, the payload and the signature are encrypted. Similar to the case of the encrypted data(=1), the value of the digital signature for the payload may be substituted thereinto. By so doing, if the value stored in the decrypted signature agrees with a value identified at the receiving side or a computed value, the decryption will be done normally and therefore the validity of data stored in the payload or data stored in the security header and payload header can be verified. Each feed length is as follows, for instance. That is, the security header is of 32 bytes, the payload is of 100 bytes, and the signature is of 16 bytes, for instance.

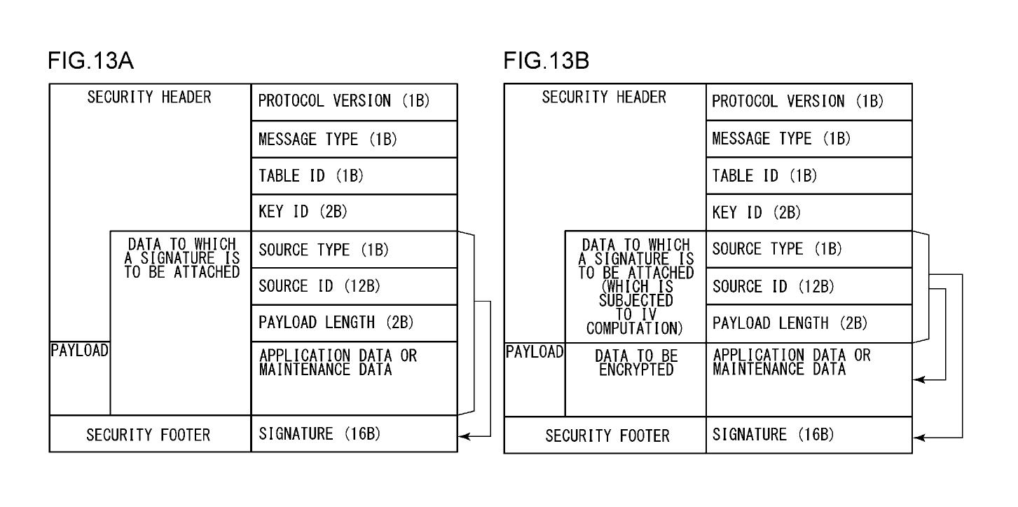

Here, AES encryption is used in the inter-vehicular communication as the encryption method. FIGS. 13A and 13B show processing contents for the security frame. FIG. 13A shows a case where the data format of the message type is data with signature(=1). A digital signature is computed for a part of security header, which is namely comprised herein of source type, source ID, payload length, and payload. The thus computed value is stored in a signature of a security footer. The reason for the inclusion of the source type and the source ID in the digital signature to be computed is to prove the features of an in-vehicle unit of a source (sender of signals).

FIG. 13B shows a case where the data format of the message type is encrypted data with signature(=3). A digital signature is computed for a part of security header, which is namely comprised herein of source type, source ID, and payload length. The thus computed value is stored in a signature of a security footer. The payload is encrypted in a CBC (Cipher Block Chaining) mode. When a first block is encrypted in the CBC mode, an initial vector (hereinafter referred to as “IV”) is used. Normally, any value may be used for the initial value. However, in the communication system 100, the data stored in the payload is encrypted by binding (associating) the data to the sender of the information, thereby improving the reliability of the data. Here, the computation is done based on the source type, source ID, and payload length so as to determine the IV. More specifically, the previously-obtained value of the digital signature for the security header is used as IV. It is to be noted here that the mode used may be the other modes such as CFB (Cipher FeedBack) mode, OFB (Output FeedBack) mode, and CTR (CounTeR) mode. Note that a signature scheme with verification may be used. Among others, a CCM (Counter with CBC-MAC) is well known for this method. In the CCM mode, the CRT mode is used for encryption, and CBC-MAC for the payload is used for the signature.

A description is now given of the processing performed in the road-to-vehicle communication. As described above, a public key is used for the signature, and a symmetric key is used for the data. RSA, DSA, ECDSA and the like are used as methods based on the public key cryptosystem. The digital signature scheme is comprised of key generation algorithm, a signing algorithm, and a signature verifying algorithm. The key generation algorithm corresponds to an advance preparation of a digital signature. The key generation algorithm outputs a public key and a private key of the user. Each base station apparatus 10 keeps the private key, whereas the public key is open to the terminal apparatuses 14.

When the base station apparatus 10 that has prepared the signature is to prepare a digital signature for a message using a signing algorithm, each base station apparatus 10 prepares the digital signature for the message with the private key kept and attaches the thus prepared digital signature to the message. Since the private key is only known to the base station apparatus 10 that has signed, the private key serves itself as a means for identifying the preparer of the message to which the digital signature has been attached. A terminal apparatus 14 that received the message and the digital signature verifies whether the digital signature is valid or not, by running the signature verifying algorithm. In so doing, the terminal apparatus 14 enters a public key of the base station apparatus 10 into the signature verifying algorithm. The signature verifying algorithm determines if the digital signature has been surely prepared by the base station apparatus 10, and then outputs its result.

About 200 bytes are required for the public key certificate and the digital signature in the public key cryptosystem. On the other hand, data of about 100 bytes is stored in the packet broadcast from the terminal apparatus 14 in the communication system 100. Accordingly, if the public key certificate and the digital signature in the public key cryptosystem are added to the packet in the inter-vehicular communication, the transmitting efficiency will be significantly reduced. However, the size of packets in the road-to-vehicular communication is larger than the size of packets in the inter-vehicular communication. Thus, the degradation of the transmitting efficiency is suppressed even if the public key certificate and the digital signature in the public key cryptosystem are added to the packet in the road-to-vehicular communication. RSA, DSA, ECDSA and the like are usable as digital signature schemes based on the public key cryptosystem.

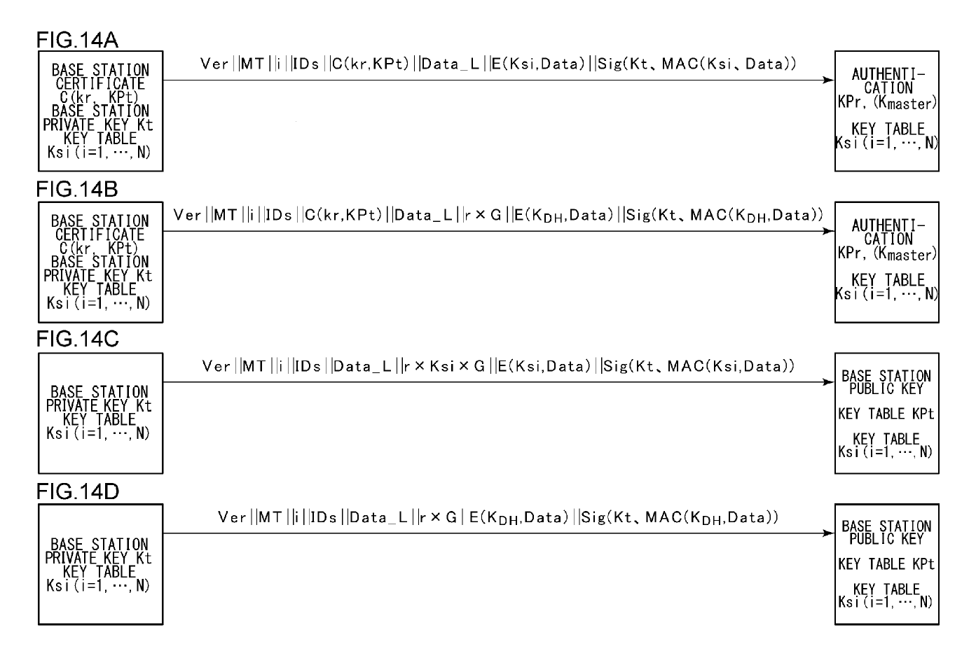

FIGS. 14A to 14D show an overview of security processing performed by the base station apparatus 10 according to an exemplary embodiment of the present invention. FIG. 14A shows a case where an elliptic curve digital signature algorithm (ECDSA) is used for the generation of the signature. In this algorithm, the protocol version is denoted by “Ver”, the message type is denoted by “MT”, and the source type indicating that the information is sent from the base station apparatus 10 is denoted by “IDs”. And a value(=3) indicating that the sender of the information is a roadside unit is set in “IDs”. Also, an elliptic curve encryption is used here as the public key cryptosystem, and a signature (secret) key of certificate authority is denoted by “Kr”, an authentication (public) key is denoted by “KPr”, a public key of the base station apparatus 10 is denoted by “KPt”, and a private key of the base station apparatus 10 is denoted by “Kt”. For simplicity, table IDs and key IDs used to identify symmetric keys are collectively denoted by “i”, and a symmetric key contained in the symmetric key table identified by “i” is denoted by “Ksi”. The left side of FIG. 14A corresponds to the base station apparatus 10, whereas the right side thereof corresponds to the terminal apparatus 14. Notations above the arrow indicate a processing performed on a packet sent from the base station apparatus 10 to the terminal apparatus 14. In FIGS. 14A to 14D, a string starting from “Ver” corresponds to the security header portion shown in FIG. 12, a string starting from “E” corresponds to the payload portion shown in FIG. 12, and a string starting from “Sig” corresponds to the signature portion shown in FIG. 12.

A public key certificate (also called base station certificate) C(kr, KPt) of a base station is expressed as follows.

C(kr, KPt)=KPt∥Sig(Kr, Mac(Kₘₐₛₜₑᵣ, Kpt))

In this expression, “∥” indicates a concatenation of data, “Sig” indicates a digital signature in ECDSA, and “Mac” indicates AES-CBC-MAC. That is, ECDAS(k, a) is a value of the digital signature by ECDAS obtained with the use of a public key k. Similarly, Mac(k, a) is a MAC value for data a which is computed with the use of a key k. Kₘₐₛₜₑᵣ is a symmetric key that is shared in the entire system and used for the MAC computation of a certificate. Such a base station certificate proves that the public key KPt of the base station is valid. “E” indicates a symmetric key cryptosystem, which is herein the encryption with AES-CBC, and E(Ksi, Data) indicates that data “Data” is encrypted. “Sig(Kt, Mac(Ksi, Data))” indicates the value of a digital signature evaluated for Mac(Ksi, Data) with a key Kr. Suppose that the base station certificate C(kr, KPt) has been verified valid with the authentication (public) key KPr. This means not only that this base station certificate is a base station certificate given to the proper (valid) base station apparatus 10 but also that the electronically-signed information that is to be verified with the public key KPt contained in the base station certificate is information transmitted from the proper base station apparatus 10.

In the road-to-vehicle communication, the format of security frame transmitted from the base station apparatus 10 to the terminal apparatuses 14 is Ver∥MT∥i∥IDs∥C(kr, KPt)∥Data_L∥E(Ksi, Data)∥Sig(Kt, MAC(Ksi, Data)). Here, “Data_L” indicates the payload length, and “Data” indicates data stored in the payload. Thus, the base station certificate C(kr, KPt) is stored instead of the source ID in the format of the inter-vehicular communication as shown in FIG. 13B. Also, stored in the security header is the value of the digital signature by ECDSA, instead of the value of the electronic signal computed for part of the security header and the payload. In FIG. 14A, the base station certificate C(kr, KPt), the base station private key Kt, and the symmetric key table Ksi (i=0, . . . , N−1) are stored beforehand in the base station apparatus 10. And the authentication key KPr and the symmetric key Kₘₐₛₜₑᵣ, which is commonly used in the entire system, are stored beforehand in the terminal apparatuses 14. Though not shown, an elliptic curve and a base point G used in the elliptic curve encryption are stored in both the base station apparatus 10 and the terminal apparatuses 14.

FIG. 14B shows encryption where a key K_{DH} exchanged through the key exchange by EC-DH is used. This corresponds to turning an encryption key into random number(s). Here, the key Ksi in a symmetric key table is used as a private key of the terminal apparatus 14. The public key of the terminal apparatus 14 is obtained through the calculation “Ksi×G”. G indicates a base point, and X indicates a multiplication on an elliptic curve. The common coordinates is denoted by “”, r is a random number, and r is generated every time the information is broadcast. The key K_{DH} that encrypts the data is indicated by “f(r×Ksi×G)”. A function f is a function by which the key K_{DH} is obtained from the coordinates on the elliptic curve.

In the road-to-vehicle communication, the format of security frame transmitted from the base station apparatus 10 to the terminal apparatuses 14 is Ver∥MT∥i∥IDs∥C(kr, KPt)∥Data_L∥r×G∥E(K_{DH}, Data)∥Sig(Kt, MAC(K_{DH}, Data)). It should be noted here that the function f is stored in both the base station apparatus 10 and the terminal apparatuses 14.

FIG. 14C corresponds to a case where a public key of the base station apparatus 10 is commonly used so as to reduce the overhead. In this case, the base station certificate is not sent out. FIG. 14D corresponds to a case where a public key of the base station apparatus 10 is first commonly used to thereby reduce the overhead and then the key exchange is done by EC-DH. In FIGS. 14C and 14D, the verification of certificate is skipped. Since the base station certificate is not sent out, the base station apparatus 10 does not store the base station certificate C(kr, KPt). Similarly, the terminal apparatus 14 does not store the authentication key KPr used to verify the base station certificate and the symmetric key Kₘₐₛₜₑᵣ that is commonly used in the entire system. Instead, the public key KPt of the base station apparatus 10 is stored in advance. In this case, a plurality of base station apparatuses 10 cannot be individually identified but whether the packets are sent from the base station apparatuses 10 or not can be checked.

FIGS. 14A to 14D shows an overview of security processing performed by a base station apparatus according to an exemplary embodiment of the present invention. Since the encryption of Data is not required when the data format of the message type is data with signature(=1), E(Ksi, Data) or E(K_{DH}, Data) is preferably replaced by Data. Though a description has been given above of a case where “MAC (Message Authentication Code)” is given to the digital signature in the public key encryption, a hash function, such as SHA224 or SHA256, may be used in substitution for AES-CBC-MAC. In such a case, “Hash” is used in place of “MAC” and therefore the certification C(kr, KPt) is expressed as C(Kr, KPt)=KPt∥Sig(Kr, Hash(KPt)). The same applies to the signature for Data. In this case, the symmetric key Kₘₐₛₜₑᵣ, which is commonly used in the entire system, may not be stored in FIGS. 14A and 14B.

Similar to the inter-vehicular communication, not only Data but also the digital signature may be encrypted. In the road-to-vehicle communication, in FIG. 14A, the format of security frame transmitted from the base station apparatus 10 to the terminal apparatuses 14 is Ver∥MT∥i∥IDs∥C(kr, KPt)∥Data_L∥E(Ksi, Data)∥Sig(Kt, MAC(Ksi, Data)). And in FIG. 14B, the format thereof is Ver∥MT∥i∥IDs∥C(kr, KPt)∥Data_L∥r×G∥E(K_{DH}, Data)∥Sig(Kt, MAC(K_{DH}, Data)). In FIGS. 14C and 14D, the formats thereof are similar.

A first modification of the exemplary embodiments is now described. Similar to the exemplary embodiments, a purpose of the first modification is to ensure the secrecy of communication contents in a radio communication zone and eliminate the fake third party and the like. Now, refer back to FIGS. 7A and 7B. A packet transmitted from the base station apparatus 10 to the terminal apparatus 14 in the road-to-vehicle communication is transmitted in the road-to-vehicle transmission period assigned to a subframe as shown in FIG. 7A. Also, a plurality of RSU packets are assigned to the road-to-vehicle transmission period. Each RSU packet corresponds to each road-to-vehicle packet. Now, refer to FIGS. 14A to 14D. In the first modification, assume that a leading road-to-vehicle packet (at the beginning) of the road-to-vehicle transmission period is subjected to FIG. 4A, and packets subsequent to the leading packet are subjected to FIG. 14C. That is, the subsequent road-to-vehicle packets in the road-to-vehicle transmission period are verified by using a roadside-unit certificate transmitted using the leading road-to-vehicle packet. By employing such a structure as described above, a roadside-unit certificate specific to each base station apparatus 10 is provided, so that individual authentications of the base station apparatuses 10 and the overhead for the road-to-vehicle packets can be reduced. Even though the leading road-to-vehicle packet of the road-to-vehicle transmission period is subjected to FIG. 4B, and the packets subsequent to the leading packet are subjected to FIG. 14D, the similar advantageous effects are gained.

A second modification of the exemplary embodiments is now described. In the second modification, the processing of the subsequent road-to-vehicle packets of the road-to-vehicle transmission period according to the first modification is varied. Now, refer to FIGS. 14A to 14D. In the second modification, assume that the leading road-to-vehicle packet of the road-to-vehicle transmission period is subjected to FIG. 14A or FIG. 14C. The subsequent packets of the road-to-vehicle transmission period transmit a digest D(C(kr, KPt)) of the roadside-unit certificate instead of the roadside-unit certificate C(kr, KPt). The digest is a value requested from the roadside-unit certificate and is information by which to identify the roadside-unit certificate. The data amount of the digest D(C(kr, KPt)) of the roadside-unit certificate is extremely smaller than that of the roadside-unit certificate C(kr, KPt). A hash value or a MAC value of a roadside-unit certificate document (e.g., a roadside-unit certificate document) is used as the digest D(C(kr, KPt)).

Thus, in the road-to-vehicle communication, in the case where the leading packet is one shown in FIG. 14A, the format of security frame of the subsequent packet transmitted from the base station apparatus 10 to the terminal apparatuses 14 is Ver∥MT∥i∥IDs∥D(C(kr, KPt))∥Data_L∥E(Ksi, Data)∥Sig(Kt, MAC(Ksi, Data)). And in the case of FIG. 14B, the format thereof is Ver∥MT∥i∥IDs∥D(C(kr, KPt))∥Data_L∥r×G∥E(K_{DH}, Data)∥Sig(Kt, MAC(K_{DH}, Data)).

The terminal apparatus 14 stores the digest of a roadside-unit certificate used last for each road-to-vehicle communication and the symmetric key. If the leading road-to-vehicle packet of the road-to-vehicle transmission period is received, the roadside-unit certificate will be verified and Data will undergo the signature verification with a public key contained in the verified roadside-unit certificate. If the verification is successful, the digest of the roadside-unit certificate will be acquired and the thus acquired digest and the public key will be stored. If a subsequent road-to-vehicle packet of the roadside-to-vehicle transmission period is received, the digest D(C(kr, KPt)) contained in the received road-to-vehicle packet will be compared against the digest D(C(kr, KPt)) stored. If both agree with each other, Data contained in the subsequent road-to-vehicle packet will undergo the signature verification with the public key stored. If they do not agree with each other, this will correspond to the case where the roadside-unit certificate C(kr, KPt) is denied by the verification.

By employing the above-described structure and construction, a roadside-unit certificate specific to each base station apparatus 10 is provided, so that not only the individual authentications of the base station apparatuses 10 and the overhead for the road-to-vehicle packets can be reduced but also the subsequent road-to-vehicle packets can be verified even though the leading road-to-vehicle packet of the road-to-vehicle transmission period cannot be received.

A third modification of the exemplary embodiments is now described. In the third modification, the processing of the subsequent road-to-vehicle packets of the road-to-vehicle transmission period according to the first modification is further varied. The verification of the roadside-unit certificate and the verification of Data with a public key contained in the roadside-unit public key certificate prove that the road-to-vehicle packet containing Data is the information transmitted from the proper legitimate base station apparatus 10. In this system, it is guaranteed as shown in FIG. 7 that a road-to-vehicle packet in a particular road-to-vehicle transmission period is transmitted from the same base station apparatus 10. Thus, as for the subsequent road-to-vehicle packets of the road-to-vehicle transmission period, only a falsification detection function is given to these subsequent packets. In other words, Data is given a digital signature with a symmetric key. The subsequent road-to-vehicle packet of the road-to-vehicle transmission period in FIG. 14A is Ver∥MT∥i∥IDs∥Data_L∥E(Ksi, Data)∥MAC(Ksi, Data), and this is similar to the processing of the inter-vehicular security frame in the case of FIG. 13. The subsequent road-to-vehicle packet of the road-to-vehicle transmission period in FIG. 14B is Ver∥MT∥i∥IDs∥Data_L∥r×G∥E(K_{DH}, Data)∥MAC(K_{DH}, Data). Also, in the light of the fact that it takes some time to verify the digital signature in the public encryption scheme, the verification of the roadside-unit certificate and the verification of Data contained in the roadside-unit public certificate may be done with predetermined specific timings, and Data may be electronically signed with another timing with the symmetric key. In this case, two digital signatures are attached to the leading road-to-vehicle packet of the road-to-vehicle transmission period.

By employing such a structure as described above, a roadside-unit certificate specific to each base station apparatus 10 is provided, so that individual authentications of the base station apparatuses 10 and the overhead for the road-to-vehicle packets can be reduced and furthermore the verification processing load can be reduced. Though, in the first, second and third modifications, the packet with which to transmit the base station certificate is the leading packet of the road-to-vehicle communication period, a plurality of packets may be used to transmit the base station certificate. Similar to the exemplary embodiments, not only Data but also digital signature may be encrypted in the first, second and third modifications. Also, if the data format of the message type is data with signature(=1), Data may be replaced by non-encryption, namely E(Ksi, Data), or E(K_{DH}, Data) may be replaced by Data. It should be noted here that, in the exemplary embodiments and the first to third modifications, sharing the symmetric key K_{DH} is achieved by transmitting “r×G” and performing decryption with the key Ki. In other words, the key K_{DH} is encrypted with the key Ksi and then transmitted.

A fourth modification of the exemplary embodiments is now described. Similar to the exemplary embodiments, the fourth modification relates also to a communication system used for ITS. In the exemplary embodiments, when the first frame is used, the message header formed by the basic part is stored in the RSU packet; when the second frame is used, the message header formed by the basic part and the extended part is stored in the control packet and the RSU packet. A purpose of the fourth modification is to improve the transmitting efficient when the second frame is used. In the fourth modification, when the second frame is used, the message header formed by the basic part and the extended part is stored in the control packet only. The communication system 100 according to the fourth modification is similar to that of FIG. 1 and FIG. 2, the base station apparatus 10 according to the fourth modification is similar to that of FIG. 3, and the terminal apparatus 14 according to the fourth modification is similar to that of FIG. 8. A description is given here centering around features different from those of FIGS. 1 to 3 and FIG. 8.

When the first frame is used, the generator 46 generates the RSU packets to be broadcast in the road-to-vehicle transmission period; when the second frame is used, the generator 46 generates a control packet and the RSU packets to be broadcast in the road-to vehicle transmission period. When the first frame is used, the generator 46 has the basic part contained in the message header of the RSU packet to be broadcast; when the second frame is used, the generator 46 has the basic part and the extended part contained in the message header of the control packet to be broadcast When the second frame is used, the generator 46 does not have the RSU packet, to be broadcast, in the message header. Note that, when the second frames is used, the generator 46 may have only the message header contained in the RSU packet to be broadcast.

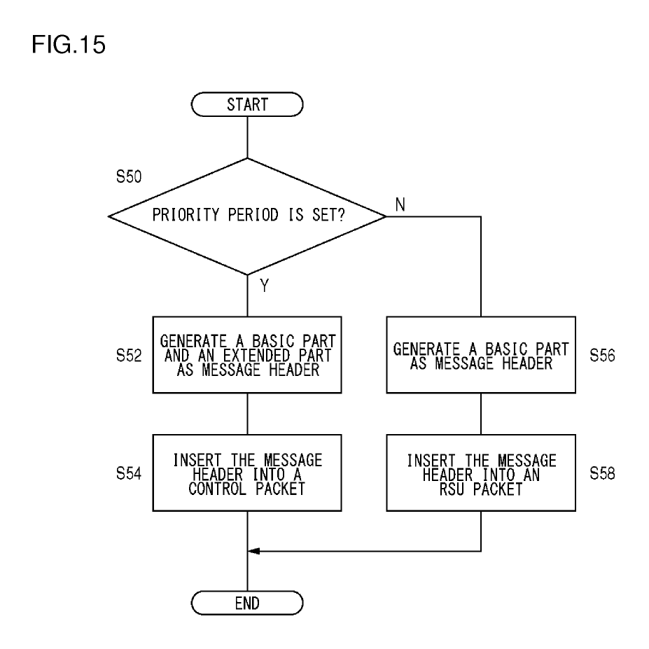

FIG. 15 is a flowchart showing a procedure for inserting a message header in the base station apparatus 10 according to a fourth modification. If a priority period is set by the setting unit 48 (Y of S50), the generator 46 will generate a basic part and an extended part as a message header (S52). The generator 46 inserts the thus generated message header into the control packet (S54). If, on the other hand, the priority period is not set by the setting unit 48 (N of S50), the generator 46 will generate a basic part as a message header (S56). The generator 46 inserts the thus generated message header into the RSU packet (S58).

By employing the exemplary embodiments, even though the packets sent from the base station apparatus cannot be received, frames are generated based on the packets sent from the other terminal apparatuses and therefore the thus generated frames can be synchronized with a frame in the base station apparatus. Also, since the frames are synchronized with the frame in the base station apparatus, any of a plurality of slots contained in the frame can be used. Also, since any of a plurality of slots in the frame is used, the collision occurring in the middle of a packet can be suppressed. Also, since the collision occurring in the middle of a packet is suppressed, the collision probability of packets can be reduced.

Also, when the first frame is used, the basic part is generated; when the second frame is used, the basic part and the extended pat are generated. Thus, a message header suited to the frame construction can be generated. Also, since the message header suited to the frame construction is generated, highly flexible inter-vehicular communications can be achieved. Also, when the first frame is used, the basic part is generated but no extended part is generated. Thus, the transmitting efficiency can be improved. Also, when the second frame is generated, the basic part and the extended part are generated. Thus, the necessary information can be conveyed. Whether or not the extended part is to be generated is determined and implemented according as the first frame is used or the second frame is used. Thus the processing can be simplified. Also, the basic part is generated without regard to whether the first frame is used or the second frame is used, so that the processing can be simplified.

Also, a packet includes an identifier by which to identify whether the basic part only is contained in the packet or both the basic part and the extended part are contained therein. Thus whether or not the extended part is contained can be notified without fail. Also, since a packet includes an identifier by which to identify whether the basic part only is contained in the packet or both the basic part and the extended part are contained therein, whether or not the extended part is contained can be notified in a simplified manner. Also, the extended part includes the size of slot(s) contained in the priority period, the ratio between the priority period and the general period, and the threshold according to which the terminal apparatus selects either the use of priority period or the use of general period. Hence, when the priority period is used, the information required for the operation can be notified.

Also, the basic part and the extended part are contained in the control packet and the RSU packet, so that the probability of receiving the signals can be enhanced in the basic part and the extended part. Also, since the probability of receiving the signals is enhanced, the processing at the terminal apparatuses can be performed accurately. Also, the RSU packet, broadcast when the first frame is used, contains the basic part, whereas the control packet and the RSU signal packet, broadcast when the second frame is used, contain the basic part and the extended part. Thus, the probability of receiving the signals can be enhanced while the degradation of the transmitting efficiency is suppressed. Since the RSU packet, broadcast when the first frame is used, contains the basic part, and the control packet, broadcast when the second frame is used, contains the basic part and the extended part, the probability of receiving the signals can be enhanced while the transmitting efficiency is improved.

The received power is used to make to distinguish between the first area and the second area, so that the range where the propagation loss is a predetermined level is defined as the first area. Also, since the range where the propagation loss is a predetermined level is defined as the first area, the vicinity of the intersection can be used as the first area. Also, the time-division multiplexing using slots is executed in the priority period, so that the error rate can be reduced. Also, CSMA/CA is executed in the general period, so that the terminal apparatuses can be flexibly adjusted.

Also, the subframes used by the other base station apparatuses are identified based on not only the packets directly received from the other base station apparatuses but also the terminal apparatuses, so that the accuracy at which the subframes in use are identified can be improved. Also, since the accuracy at which the subframes in use are identified is improved, the probability of collision among the packets sent from the base station apparatuses can be reduced. Also, since the probability of collision among the packets sent from the base station apparatuses is reduced, the terminal apparatuses can accurately recognize the control information. Also, since the control information can be accurately recognized, the road-to-vehicle transmission period can be accurately recognized. Also, since the road-to-vehicle transmission period is accurately recognized, the collision probability of packets can be reduced.

Also, those excluding the subframes in use are preferentially used, so that the possibility that the packets can be transmitted with overlapped timings can be reduced. Also, if any subframes are used by the other base station apparatus, subframes whose received power is low are selected, so that the effect of interference between the packets can be suppressed. Also, the received power of a terminal apparatus is used as the received power from the other base station apparatuses that are the senders of the control information relayed by said terminal apparatus, so that the process of estimating the received power can be carried out with ease.

Also, since a symmetric key in the symmetric key cryptosystem is used as the encryption key in the inter-vehicular communication, the size of packet and the processing load in the inter-vehicular communication can be reduced. Also, in the road-to-vehicle communication, a public key and a private key in the public key cryptosystem are used for signatures in the inter-vehicular communication, while a symmetric key in the symmetric key cryptosystem is used for data. Hence, the spoofing and the like can be further suppressed than in the inter-vehicular communication. Also, since a plurality of symmetric keys are used, the leakage risk of symmetric key can be reduced.

The present invention has been described based on the exemplary embodiments. The exemplary embodiments are intended to be illustrative only, and it is understood by those skilled in the art that various modifications to constituting elements and processes as well as arbitrary combinations thereof could be further developed and that such modifications and combinations are also within the scope of the present invention.

The features and characteristics of the present exemplary embodiment may also be defined by the following Items:

### (Item 1)

A terminal apparatus comprising:

a communication unit configured to receive a packet sent from a base station apparatus; and

a processing unit configured to process the packet received by said communication unit,

wherein, in the packet received by said communication unit from the base station apparatus, a private key complying with a public key cryptosystem is used for a digital signature, and a symmetric key complying with a symmetric key cryptosystem is used for data.

### (Item 2)

A terminal apparatus according to Item 1, wherein said communication unit receives a packet sent from another terminal apparatus.

### (Item 3)

A terminal apparatus according to Item 1, wherein when there are two or more subframes, which are not used by another base station apparatus, in a plurality of subframes constituting a frame, a packet sent from the another base station is received in a subframe randomly selected by the base station apparatus.

### (Item 4)

A terminal apparatus according to Item 1, wherein when there is no subframes unused by another base station in a plurality of subframes constituting a frame, a packet sent from the another base station is received in a subframe selected by the base station apparatus based on a received power.

### (Item 5)

A terminal apparatus according to Item 1, wherein the packet received by said communication unit from the base station apparatus contains a public key certificate and a digital signature complying with the public key cryptosystem.

### (Item 6)

A terminal apparatus according to Item 1, wherein, in the packet received by said communication unit from the another terminal apparatus, a symmetric key complying with the symmetric key cryptosystem is used for the digital signature.

### (Item 7)

A terminal apparatus according to Item 1, wherein the symmetric key used in said communication unit is one of a plurality of symmetric keys put together as a symmetric key table.

### (Item 8)

A terminal apparatus according to Item 7, wherein the symmetric key table where the plurality of symmetric keys used are put together is managed through table IDs.

### (Item 9)

A terminal apparatus according to Item 1, wherein the packet received by said communication unit includes a source type ID that is set according to a type of a sender of the packet.

### (Item 10)

A terminal apparatus according to Item 1, wherein said communication unit receives a plurality of packets from the base station apparatus in a partial period of a subframe, and

said communication unit verifies a subsequent packet by using a roadside-unit certificate included in a leading packet.

### (Item 11)

A terminal apparatus according to Item 1, wherein said communication unit receives a plurality of packets from the base station apparatus in a partial period of a subframe, and

(1) if a leading packet is received, said communication unit verifies the roadside-unit certificate and verifies the signature of the data by using the public key included in the roadside-unit certificate;

(2) if verification is successful, said communication unit acquires a digest of the roadside-unit certificate and holds the acquired digest and the public key; and

(3) if a subsequent packet is received and when the digest of the roadside-unit certificate included in the received packet agrees with the digest of the roadside-unit certificated held, said communication verifies the signature of the data included in the subsequent packet with the public key held.

### (Item 12)

A terminal apparatus according to Item 1, wherein with predetermined timing, said communication unit verifies the roadside-unit certificate and verifies the data with the public key included in the roadside-unit public key certificate, and

with another timing, said communication unit verifies the digital signature of the data.

What is claimed is:

1. A terminal apparatus comprising:
a communication unit configured to receive a packet sent from a base station apparatus; and
a processing unit configured to process the packet received by said communication unit,
wherein, in the packet received by said communication unit from the base station apparatus, a private key complying with a public key cryptosystem is used for a digital signature, and a symmetric key complying with a symmetric key cryptosystem is used for data.

2. A terminal apparatus according to claim 1, wherein said communication unit receives a packet sent from another terminal apparatus.

3. A terminal apparatus according to claim 1, wherein when there are two or more subframes, which are not used by another base station apparatus, in a plurality of subframes constituting a frame, a packet sent from the another base station is received in a subframe randomly selected by the base station apparatus.

4. A terminal apparatus according to claim 1, wherein when there is no subframes unused by another base station in a plurality of subframes constituting a frame, a packet sent from the another base station is received in a subframe selected by the base station apparatus based on a received power.

5. A terminal apparatus according to claim 1, wherein the packet received by said communication unit from the base station apparatus contains a public key certificate and a digital signature complying with the public key cryptosystem.

6. A terminal apparatus according to claim 1, wherein, in the packet received by said communication unit from the another terminal apparatus, a symmetric key complying with the symmetric key cryptosystem is used for the digital signature.

7. A terminal apparatus according to claim 1, wherein the symmetric key used in said communication unit is one of a plurality of symmetric keys put together as a symmetric key table.

8. A terminal apparatus according to claim 7, wherein the symmetric key table where the plurality of symmetric keys used are put together is managed through table IDs.

9. A terminal apparatus according to claim 1, wherein the packet received by said communication unit includes a source type ID that is set according to a type of a sender of the packet.

10. A terminal apparatus according to claim 1, wherein said communication unit receives a plurality of packets from the base station apparatus in a partial period of a subframe, and
said communication unit verifies a subsequent packet by using a roadside-unit certificate included in a leading packet.

11. A terminal apparatus according to claim 1, wherein said communication unit receives a plurality of packets from the base station apparatus in a partial period of a subframe, and
(1) if a leading packet is received, said communication unit verifies the roadside-unit certificate and verifies the signature of the data by using the public key included in the roadside-unit certificate;
(2) if verification is successful, said communication unit acquires a digest of the roadside-unit certificate and holds the acquired digest and the public key; and
(3) if a subsequent packet is received and when the digest of the roadside-unit certificate included in the received packet agrees with the digest of the roadside-unit certificated held, said communication verifies the signature of the data included in the subsequent packet with the public key held.

12. A terminal apparatus according to claim 1, wherein with predetermined timing, said communication unit verifies the roadside-unit certificate and verifies the data with the public key included in the roadside-unit public key certificate, and
with another timing, said communication unit verifies the digital signature of the data.
